(19) United States
(12) Patent Application Publication
(10) Pub. No.: US 2010/0078909 A1
(43) Pub. Date: Apr. 1, 2010

(54) Baby walker as walk helper

(76) Inventor: Chung-Jen Cheng, Sigang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,170

(22) Filed: Sep. 30, 2008

(51) Int. Cl. B62B 7/00; A61H 3/04

(52) U.S. Cl. 280/87.051; 482/68

(57) ABSTRACT

A baby walker which can also be used as a walk-helper. In this baby walker, a mobile frame with its rear side as an open-end is pivotally supported by foldable leg units supported on the upper end of a base. A support frame with its one end also as an open-end is so disposed that its open-end is oriented to the front end of the mobile frame. The support frame is positioned on the mobile frame by interlinking engagement such that an accommodation space is formed between the mobile frame and the support frame for the assembly with a seat frame. When the seat frame is removed first and the support frame is positioned on the mobile frame by interlinking engagement with the opened end of the support frame to be oriented to the rear end of the mobile frame, the baby walker is transformed to be a walk-helper.

### BACKGROUND OF THE INVENTION

1. Field of the Invention

This invention relates to a baby walker which can also be used as an walk-helper, especially to a baby walker as an walk-helper that can be used as a baby walker for infants to be seated therein for promoting walking when infant just learn to walk, and that can also be used as an walk-helper by which infants can lean on the support frame with his hands to learn walking after infants have learned to walk for a period of time. Thus, its function is diversified and the foldable leg units can be collapsed when not in use, so as to reduce stocking space for storage.

2. Brief Description of the Prior Art

Generally, infants begin to stand up and learn to walk when they grow up to 10 months. At this stage, parent usually buy baby walker for infants to be seated therein to practice walking. Ordinary baby walker is for infants to ride in its seat padding and to move freely accompanying with the moving force of the infant's two legs generated by the contact of the infant's two legs and the floor.

The above baby walker can only be used for riding of infants who are learning to walk, usually it is made to match the stature of infants who belong to this stage to learn walking. It happens that baby walker cannot be used anymore when the infants grow up to a certain extent. In this case, a walk-helper is often separately purchased so that infants can lean on the walk-helper with their hands to move for walking learning. Referring to FIG. 8 of a perspective structural view of a prior art, the walk-helper (4) has a base (41) which is provided with several sliding wheels (42), Support columns (43) are provided on the upper end surface of the base (41) on which a leaning module (44) is assembled thereto. The infants can lean on the leaning module (44) with their hands to push the walk-helper so that the walk-helper (4) either slides or moves with the sliding wheels (42) of the base (41) for promoting walking.

The above baby walker and the walk-helper can achieve expected effectiveness of promoting walking for infants, but many disadvantages have been found in practical application and will be listed as below:
1. So far, baby walker and walk-helper have to be purchased separately for walking promotion of infants. This will not only cause inconvenience in the use of the baby walker and the walk-helper, but also place a big financial burden on their parent's shoulders.
2. Usually, both the baby walker and the walk-helper are of fixed type structure and cannot be folded when they are not in use. Thus, users often suffer large space required for storage.

In view of the above disadvantages, the inventor of this invention has proposed a baby walk concurrent as a walk-helper according to the research and improvement conducted on conventional structure and based on profound experience in R&D and manufacturing in relevant field, with a purpose to achieve better performance value in practical application.

### SUMMARY OF THE INVENTION

In the baby walk as an walk-helper according to the present invention, a mobile frame having its rear side formed as an open-end is pivotally supported by foldable leg units supported on the base, interlinking slots being provided oppositely on both sides of the mobile frame. A support frame with its one end also formed as an open-end has interlinking blocks, corresponding to the interlinking slots of the mobile frame, provided respectively on both sides. The support frame is disposed with its open-end oriented to the front end of the mobile frame and is positioned on the mobile frame by the insertion of the interlinking blocks into the interlinking slots, so that an accommodation space is formed between the mobile frame and the support frame for the assembly and accommodation of a seat frame. Thus, a baby walker is completed for ready use. On the other hand, if the seat frame is removed first and then allow the support frame to be positioned on the mobile frame by interlinking engagement with the open-end of the support frame oriented to the rear end of the mobile frame, the baby walker is transformed to a walk-helper such that infants can lean on the support frame with their hands to promote walking. In this way, this invention is diversified in its function in such a manner that it can be used as a baby walker for infants to be seated therein for walking promotion when infants just learn to walk; on the other hand, it can also be used as an walk-helper by which infants can lean on the support frame with their hands to learn walking after infants have learned to walk for a period of time. The foldable leg units can be collapsed when not in use, so as to reduce storage space. Therefore, its total availability in practical application is intensified.

### DETAILED DESCRIPTION OF THE PREFERRED EMBODIMENTS

The technical content, objects and effectiveness of the present invention will become more apparent by the detailed description of a preferred embodiment of the present invention in conjunction with the accompanying drawings.

Firstly referring to FIG. 1 in which a perspective exploded structural view of the present invention is shown, the baby walker as a walk-helper of the present invention is formed by a main body (1), a support frame (2) and a seat frame (3).

In the main body (1), a mobile frame (13) is pivotally supported by foldable leg units (12) which are supported on the upper end of a base (11). Guiding grooves (111) opposite to each other are provided at both inner sides of the base (11). Each foldable leg unit (12) has two rods (121) connected in crossover shape in which the bottom end of one rod (121) is located within the guiding groove (111) to slide therein. The mobile frame (13) has its rear side formed as an open-end (131) the inner edge of which are provided with an abutting ridge (132). Interlinking slots (133) opposite to each other are respectively provided at both sides of the mobile frame (13).

The support frame (2) with its one end also formed as an open-end (21) has interlinking blocks, corresponding to the interlinking slots (133) of the mobile frame (13), provided respectively on both sides.

The seat frame (3) has a central cavity (31) in its center for accommodation of seat padding (not shown). Corresponding to the abutting ridge (132) of the mobile frame (13) of the main body (1), an abutting recess (32) is formed at the outer edge of the seat frame (3). A hook portion (33) is provided at the rear end of the seat frame (3) for engaging with the support frame (2).

Referring to FIG. 2 showing a perspective assembled structural view of the present invention in using state together with FIG. 3 showing a sectional assembled structural side view of the present invention in using state, the support frame (2) is disposed with its open-end (21) oriented to the front end of the mobile frame (13) and is positioned on the mobile frame (13) by inserting the interlinking blocks (22) of the support frame (2) into the interlinking slots (133) of the mobile frame (13), so that an accommodation space is formed between the mobile frame (13) and the support frame (2). When the seat frame (3) is assembled and accommodated in that accommodation space, a baby walker is thus formed and ready for use by the abutment of the abutting recess (32) of the seat frame (3) with the abutting ridge (132) of the mobile frame (13) together with the hooking engagement of the hook portion (33) of the seat frame (3) with the support frame (2).

On the other hand, referring to FIG. 4 showing another perspective exploded structural view of the present invention in using state together with FIG. 5 showing a perspective assembled structural view of the present invention in using state, the baby walker can also allow the open-end (21) of the support frame (2) to be oriented to the rear end of the mobile frame (13). Similarly, the support frame (2) is positioned on the mobile frame (13) by inserting the interlinking blocks (22) of the support frame (2) into the interlinking slots (133) of the mobile frame (13), thus the baby walker is transformed to a walk-helper such that infants can lean on the support frame (2) with their hands to promote walking.

Furthermore, when the baby walker of the present invention is to be shrunk, referring to FIG. 6 showing a structural side view of the present invention together with FIG. 7 showing a structural side view of the present invention in shrunk state, the mobile frame (13) can be moved downward to the base (11) to cause the bottom end of one rod (121) of each foldable leg unit (12) sliding within the guiding groove (111), and the foldable leg units (12) provided between the base (11) and the mobile frame (13) are simultaneously collapsed onto the base (11).

The above embodiment and drawings are not used to limit the structural aspect of dimension of the present invention. Appropriate variations or modifications conducted by the person with general acknowledge in any technical field is considered to be still within the scope of the invention.

It is apparent from the above description concerning the composition of elements and the implementation, the present invention has the following advantages when comparing with prior art.

1. In this invention, a mobile frame with its rear end formed as an open-end is provided, and a support frame with its one end also formed as an open-end is so disposed that its open-end is oriented to the front end of the mobile frame. Then the support frame is positioned on the mobile frame by interlinking engagement such that an accommodation space is formed between the mobile frame and the support frame for assembling with a seat frame. Thus, a baby walker is completed and is ready for use. On the other hand, if the seat frame is removed first and then allow the support frame to be positioned on the mobile frame by interlinking engagement with the open-end of the support frame to be oriented to the rear end of the mobile frame, then the baby walker is transformed to a walk-helper such that infants can lean on the support frame with their hands to learn walking. In this way, this invention is diversified in its function in such a manner that it can be used as a baby walker for the infants to be seated therein for promoting walking when infant just learn to walk; on the other hand, it can also be used as an walk-helper by which infants can lean on the support frame with their hands to learn walking after infant has learned to walk for a period of time.

2. In this invention, the mobile frame is pivotally supported on foldable leg units supported on the base. When not in use, the baby walk is able to be shrunk in volume by the collapse of the foldable leg units so as to reduce the required stocking space for storage. Hence, the total availability in practical implementation is enhanced.

Summing up above, the embodiment of the present invention is surely able to reach expected effectiveness in application, and the specific structure disclosed herein is not only unprecedented in the same category of product but also not open to the public before application.

### BRIEF DESCRIPTION OF THE DRAWINGS

FIG. 1 is a perspective exploded structural view of the present invention.

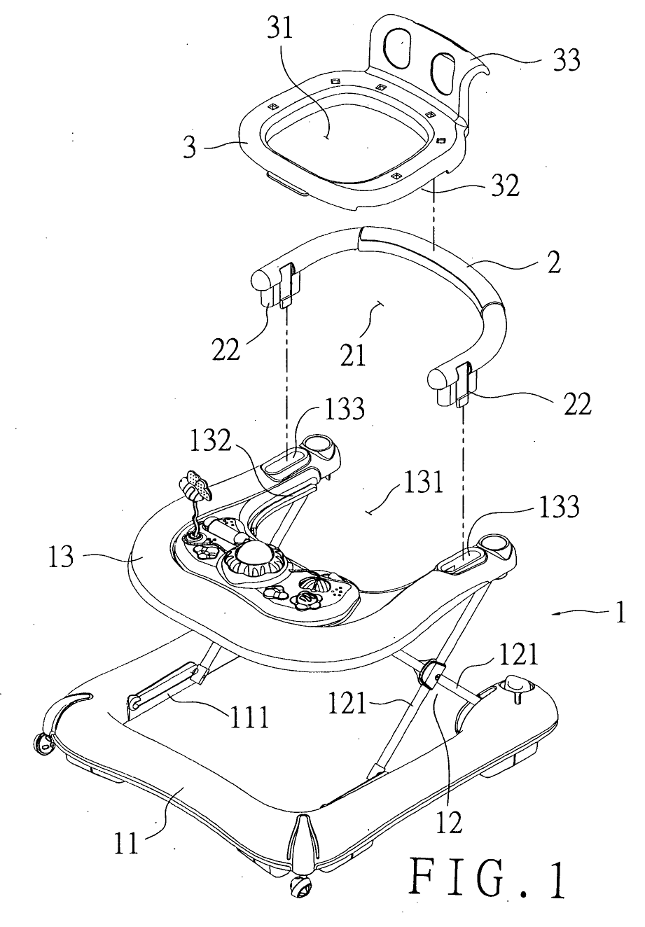

FIG. 2 is a perspective assembled structural view showing the present invention in use state.

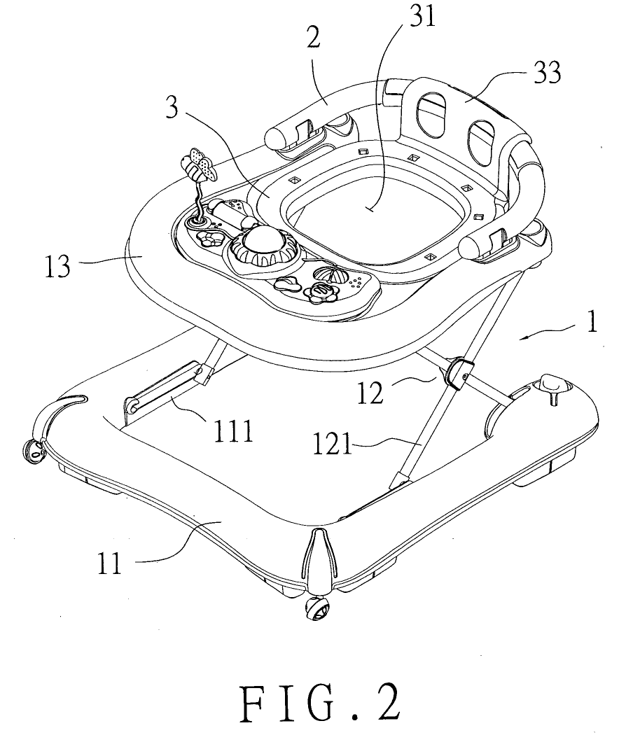

FIG. 3 is a sectional assembled structural side view of the present invention.

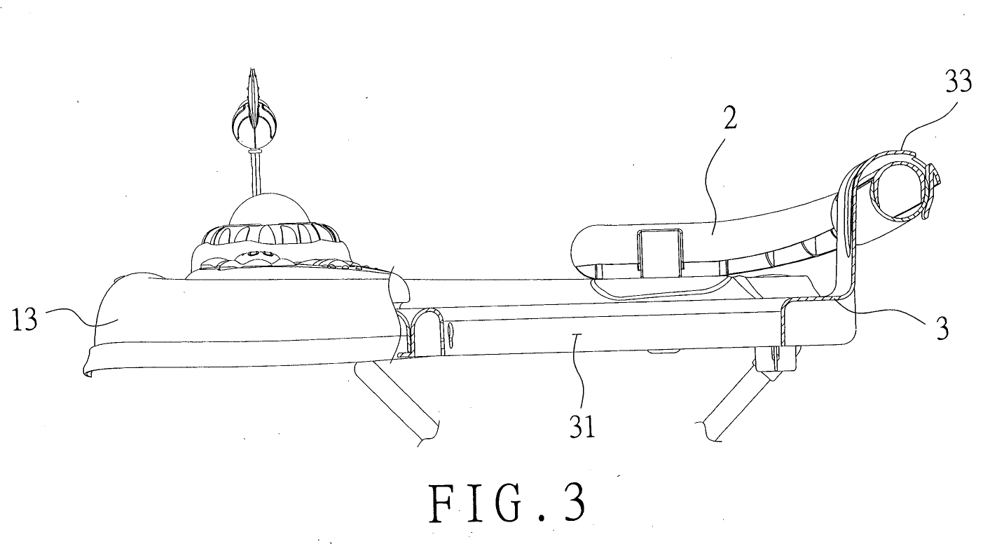

FIG. 4 is another perspective assembled structural view showing the present invention in use state.

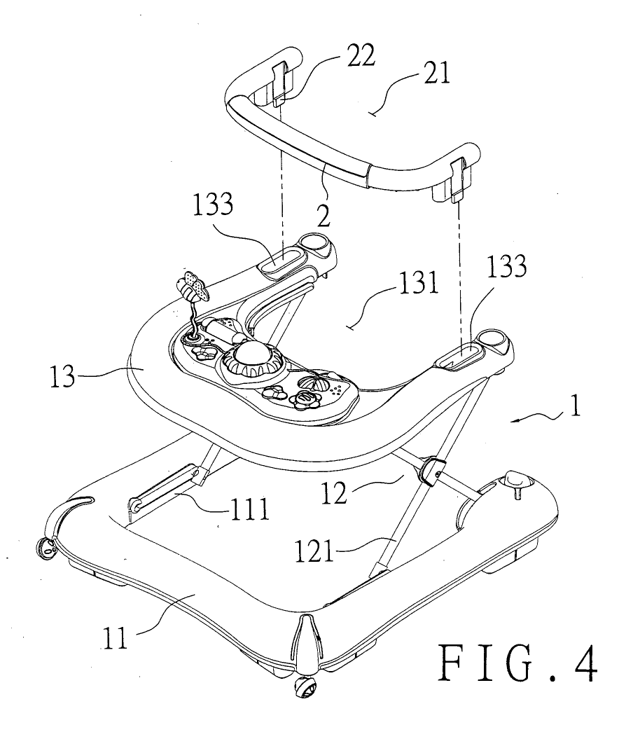

FIG. 5 is still another perspective assembled structural view showing the present invention in use state.

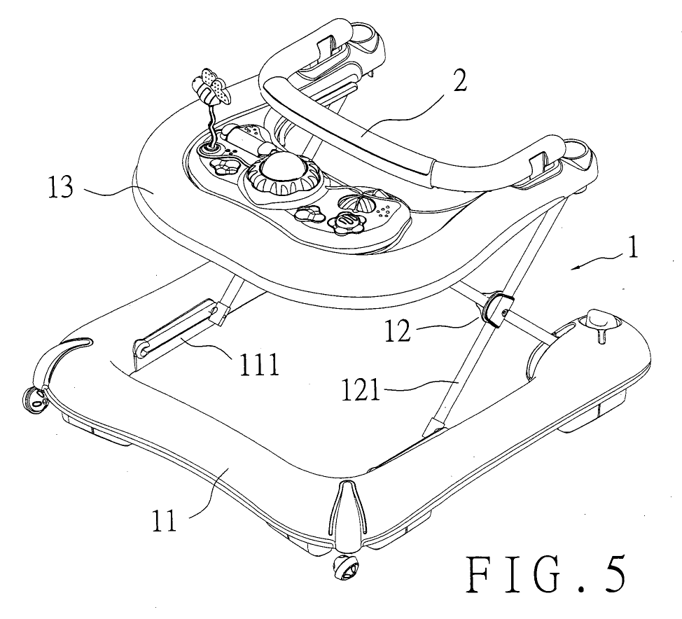

FIG. 6 is a side structural view of the present invention.

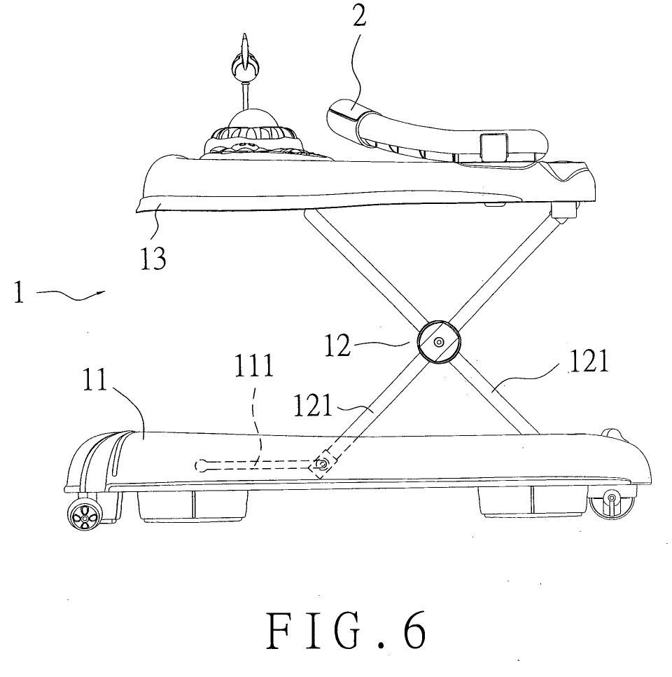

FIG. 7 is side structural view of the present invention in shrunk state.

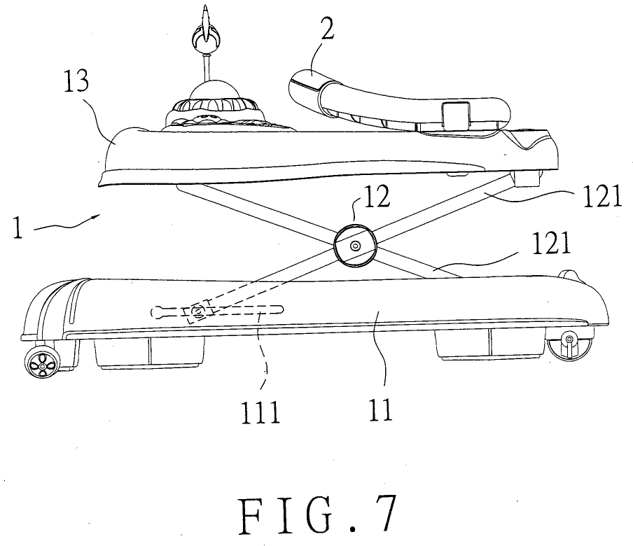

FIG. 8 is a perspective structural view of a prior art.

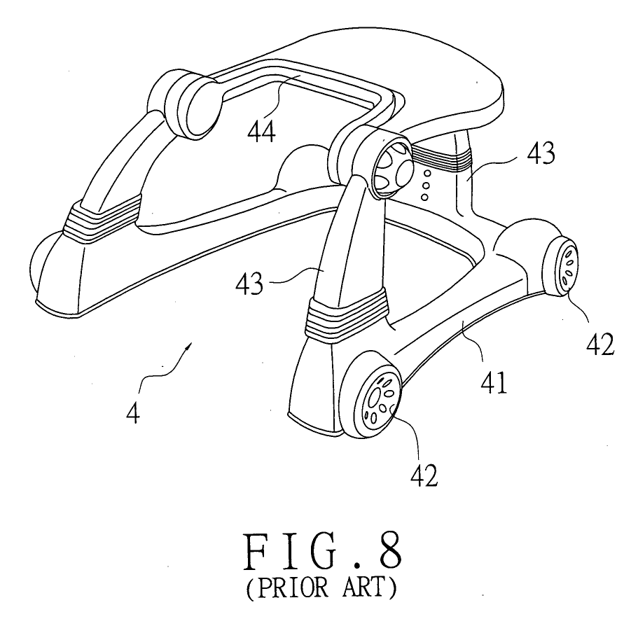

What is claimed is:

1. A baby walker as a walk-helper, formed by a main body (1), a support frame (2) and a seat frame (3), wherein:
in said main body (1), a mobile frame (13) is pivotally supported on a foldable leg units (12) which are supported on the upper end of a base (11); said mobile frame (13) having its rear end formed as an open-end (131) the inner edge of which is provided with an abutting ridge (132); interlinking slots (133) opposite to each other being respectively provided at both sides of the mobile frame (13);
said support frame (2) with its one end also formed as an open-end (21) having interlinking blocks, corresponding to the interlinking slots (133) of the mobile frame (13), provided respectively on both sides;
said seat frame (3) having a central cavity (31) in its center for accommodation of seat padding; corresponding to the abutting ridge (132) of the mobile frame (13) of the main body (1), an abutting recess (32) being formed at the outer edge of said seat frame (3); a hook portion (33) being provided at the rear end of said seat frame (3) for engaging with said support frame (2);
when said mobile frame (13), said support frame (2) and said seat frame (3) are assembled together, a baby walker is formed and ready for use; on the other hand, when said seat frame (3) is removed first and only said support frame (2) and said seat frame (3) are combined together, the baby walker is transformed to a walk-helper.

2. A baby walker as a walk-helper as claimed in claim 1, wherein guiding grooves (11) opposite to each other are provided at both inner sides of said base (11), each foldable leg unit (12) having two rods (121) connected in crossover shape in which the bottom end of one rod (121) is located within said guiding groove (111) to slide therein.
